(19) United States
(12) Patent Application Publication
(10) Pub. No.: US 2011/0160365 A1
(43) Pub. Date: Jun. 30, 2011

(54) Flame Retardant Polycarbonate Resin Composition

(75) Inventors: Seon Ae Lee, Uiwang-si (KR); Im Hyuck Bae, Uiwang-si (KR); Beom Jun Joo, Uiwang-si (KR)

(73) Assignee: CHEIL INDUSTRIES INC., Gumi-si (KR)

(21) Appl. No.: 12/979,556

(22) Filed: Dec. 28, 2010

(30) Foreign Application Priority Data
Dec. 29, 2009 (KR) 2009-0132557

(51) Int. Cl. C08K 5/5333

(52) U.S. Cl. 524/119

(57) ABSTRACT

A flame retardant polycarbonate resin composition of the present invention comprises: (A) about 30 to about 100% by weight of a polycarbonate resin; (B) about 0 to about 70% by weight of a rubber modified aromatic vinyl based copolymer resin; and (C) about 0.1 to about 40 parts by weight of a phosphorous compound or a combination of phosphorus compounds represented by the following Chemical Formula (I), per 100 parts by weight of a base resin comprising (A) and (B). The flame retardant polycarbonate resin composition of the present invention can have excellent flame retardancy and heat resistance.

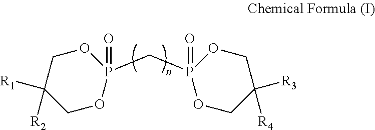

wherein R₁, R₂, R₃, and R₄ are each independently hydroxyl, phenol, phenyl, or C1-C4 alkyl; and n is an integer of 1 to 10.

### CROSS-REFERENCE TO RELATED APPLICATION

This application claims priority from Korean Patent Application No. 2009-0132557, filed Dec. 29, 2009 in the Korean Intellectual Property Office, the disclosure of which is incorporated herein by reference in its entirety

### FIELD OF THE INVENTION

The inventions relate to a flame retardant polycarbonate resin composition.

### BACKGROUND OF THE INVENTION

Generally, polycarbonate and styrene resin blend compositions can provide improved processability while maintaining high notched impact strength. Such resin blend compositions should also have good flame retardancy as well as high mechanical strength when used in the production of heat-emitting large-size injection molded products such as computer housings, office supplies, and the like.

A halogen-containing flame retardant and an antimony-containing compound can be added to the resin compositions to impart good flame retardancy. However, halogen-containing flame retardants can produce toxic gases during combustion. Therefore, there is an increased demand for the resin without a halogen flame retardant due to the harmful health effects of the gas.

Phosphoric ester flame retardants are alternatives to halogen-containing flame retardants. U.S. Pat. No. 4,692,488 discloses a thermoplastic resin composition comprising a halogen-free aromatic polycarbonate resin, a halogen-free styrene-acrylonitrile copolymer, a halogen-free phosphoric compound, a tetrafluoroethylene polymer and a small amount of ABS copolymer. U.S. Pat. No. 5,061,745 also discloses a flame retardant resin composition comprising an aromatic polycarbonate resin, an ABS graft copolymer, a styrene copolymer, phosphoric ester and a tetrafluoroethylene polymer. However, the resin compositions described above have a disadvantage in that it is necessary to add an excessive amount of phosphoric ester flame retardant in order to obtain an acceptable level of flame retardancy. This, however, can result in unsatisfactory heat resistance and surface segregation of the flame retardant agent during the molding process, called “juicing”, which can degrade the physical properties of the resin compositions.

EP 728811 discloses flame retardant resin composition including an aromatic polycarbonate, a vinyl copolymer, a graft copolymer, and a phosphazene. The composition including phosphazene as a flame retardant can exhibit reduced dripping of flaming particles during combustion without an anti-dripping agent and good heat resistance and impact strength. However, when the phosphazene is used as a flame retardant, the amount of flame retardant must be increased to achieve high flame retardancy.

### SUMMARY OF THE INVENTION

The present inventors have developed a flame retardant polycarbonate resin composition including a phosphorous compound represented by Chemical Formula (I) as a flame retardant. The compositions of the invention can overcome the problems discussed herein associated with prior flame retardant compositions. Further, the polycarbonate resin composition can minimize generation of environmental problems by not emitting a halogenated hydrogen gas.

In an exemplary embodiment of the present invention, the flame retardant polycarbonate resin composition comprises: (A) about 30 to about 100% by weight of a polycarbonate resin; (B) about 0 to about 70% by weight of a rubber modified aromatic vinyl based copolymer; and (C) about 0.1 to about 40 parts by weight of a phosphorous compound or a combination of phosphorous compounds represented by the following Chemical Formula (I), per 100 parts by weight of a base resin comprising (A) and (B).

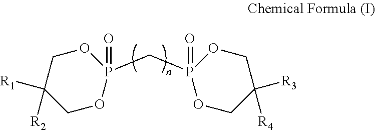

wherein R₁, R₂, R₃, and R₄ are each independently hydroxyl, phenol, phenyl, or C1-C4 alkyl; and

n is an integer of 1 to 10.

In an exemplary embodiment of the present invention, the rubber modified aromatic vinyl based copolymer resin (B) comprises: about 10 to about 100% by weight of a graft copolymer resin (B1) prepared by graft-copolymerizing about 5 to about 65% by weight of a rubbery polymer, about 34 to about 94% by weight of an aromatic vinyl monomer, about 1 to about 30% by weight of a monomer copolymerizable with the aromatic vinyl monomer, and about 0 to about 15% by weight of one or more other monomers to impart good processability and heat resistance; and about 0 to about 90% by weight of a copolymer resin (B2) prepared by copolymerizing about 60 to about 90% by weight of an aromatic vinyl monomer, about 10 to about 40% by weight of a monomer copolymerizable with the aromatic vinyl monomer, and about 0 to about 30% by weight of one or more other monomers to impart good processability and heat resistance.

In another embodiment of the present invention, the present invention provides a molded article prepared from the flame retardant resin composition of the present invention.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

(A) Polycarbonate Resin

The polycarbonate resin used in the present invention can be prepared by any method well-known to those having ordinary knowledge in the art. Exemplary polycarbonate resins useful as a component of the resin composition according to the invention can be prepared by reacting one or more diphenols represented by Chemical Formula II with phosgene, halogen formate or carbonic diester.

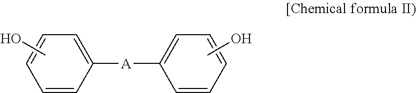

where A is a single bond, C1 to C5-alkylene, C1 to C5-alkylidene, C5 or C6 cycloalkylidene, —S—, or SO₂.

Examples of the diphenol may include without limitation hydroquinol, resorcinol, 4,4′-dihydroxy diphenyl, 2,2-bis-(4-hydroxyphenyl)-propane, 2,4-bis-(4-hydroxyphenyl)-2-methyl butane, 1,1-bis-(4-hydroxyphenyl)-cyclohexane, 2,2-bis-(3-chloro-4-hyroxyphenyl)-propane, 2,2-bis-(3,5-dichloro-4-hydroxyphenyl)-propane, and the like, and combinations thereof. Advantageous diphenols can include 2,2-bis-(4-hydroxyphenyl)-propane (also referred to as “bisphenol A”), 2,2-bis-(3,5-dichloro-4-hydroxyphenyl)-propane, and 1,1-bis-(4-hydroxyphenyl)-cyclohexane, and the like, and combinations thereof.

In the present invention, the polycarbonate resin (A) may have a weight average molecular weight (Mw) of about 10,000 to about 200,000 g/mol, for example about 15,000 to about 80,000 g/mol.

Suitable polycarbonates incorporated into the composition of the present invention may be branched in a known manner, for example, by incorporating about 0.05 to about 2 mol %, based to total quantity of diphenols used, of tri- or higher functional compounds, for example, those with three or more phenolic groups.

A homopolycarbonate, a copolycarbonate, or a combination thereof as a polycarbonate may be used in the present invention and a blend form of a copolycarbonate and a homopolycarbonate may also be used.

Some portion of the polycarbonate resin may be replaced with an aromatic polyester-carbonate resin that can be obtained by polymerization in the presence of an ester precursor, such as difunctional carboxylic acid.

The flame retardant polycarbonate resin composition of the invention may include the polycarbonate resin (A) in an amount of about 30 to about 100% by weight, for example about 40 to about 90% by weight, as another example about 50 to about 80% by weight, and as another example about 60 to about 77% by weight, based on 100% by weight of base resin including the polycarbonate resin (A) and the rubber modified aromatic vinyl based copolymer resin (B) (also referred to herein as a base resin A+B). In some embodiments, the flame retardant polycarbonate resin composition may include the polycarbonate resin (A) in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100% by weight. Further, according to some embodiments of the present invention, the amount of the polycarbonate can be in a range from about any of the foregoing amounts to about any other of the foregoing amounts.

The flame retardant composition of the invention can exhibit good flame retardancy when it includes the polycarbonate resin in an amount within the above ranges.

(B) Rubber Modified Aromatic Vinyl Based Copolymer Resin

The rubber modified aromatic vinyl based copolymer resin according to the present invention is a polymer resin wherein a rubbery polymer is dispersed in the form of particles in a matrix of an aromatic vinyl polymer. The rubber modified aromatic vinyl based copolymer resin can be prepared by polymerizing rubbery polymer, aromatic vinyl monomer, and optionally monomer polymerizable with the aromatic vinyl monomer. The rubber modified aromatic vinyl based copolymer resins can be prepared by known methods such as emulsion polymerization, solution polymerization, suspension polymerization, and bulk polymerization.

In bulk polymerization, both a graft copolymer resin and a copolymer resin excluding the rubber are prepared together in one process. In other polymerizations, the graft copolymer resin and the copolymer resin may be prepared separately. Regardless of the polymerization technique used, the rubber content in a final rubber modified aromatic vinyl based copolymer resin (B) may be about 1 to about 30% by weight based on 100% by weight of base resin, for example about 3 to about 20% by weight, and as another example about 5 to about 15% by weight. In some embodiments, the rubber content in a final rubber modified aromatic vinyl based copolymer resin can range from about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30% by weight. Further, according to some embodiments of the present invention, the rubber content in a final rubber modified aromatic vinyl based copolymer resin can be in a range from about any of the foregoing amounts to about any other of the foregoing amounts.

In exemplary embodiments of the invention, the Z-average size of rubber particles of rubber modified aromatic vinyl based copolymer resin can range from about 0.1 to about 6.0 μm, for example from about 0.25 to about 4 μm. In some embodiments, the Z-average particle size of the rubber can range from about 0.1, 0.2, 0.3, 0.4, 0.5, 0.6, 0.7, 0.8, 0.9, 1, 2, 3, 4, 5, or 6 μm. Further, according to some embodiments of the present invention, the Z-average particle size of the rubber can be in a range from about any of the foregoing sizes to about any other of the foregoing sizes.

Exemplary rubber modified aromatic vinyl based copolymer resins can include without limitation acrylonitrile-butadiene-styrene (ABS) copolymer resins, acrylonitrile-ethylenepropylene rubber-styrene (AES) copolymer resins, acrylonitrile-acrylic rubber-styrene (AAS) copolymer resins, high impact polystyrene (HIPS) and the like, and combinations thereof.

In the present invention, the rubber modified aromatic vinyl based copolymer resin (B) can include a graft copolymer resin alone or a combination of a graft copolymer resin and a copolymer resin, depending on the compatibility of each other.

In exemplary embodiments, the rubber modified aromatic vinyl based copolymer resin (B) of the present invention may include a mixture of about 10 to about 100% by weight of a graft copolymer resin (B1) and about 0 to about 90% by weight of copolymer resin (B2), for example about 55 to about 90% by weight of a graft copolymer resin (B1) and about 10 to about 45% by weight of a copolymer resin (B2).

In other exemplary embodiments of the present invention, the rubber modified aromatic vinyl based copolymer resin (B) of the present invention may include a mixture of about 15 to about 50% by weight of a graft copolymer resin (B1) and about 50 to about 85% by weight of a copolymer resin (B2).

Further, in some embodiments, the rubber modified aromatic vinyl based copolymer resin (B) may include the graft copolymer resin (B1) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87 88, 89, 90, 91, 92, 93, 94, 95, 96, 97, 98, 99, or 100% by weight. Further, according to some embodiments of the present invention, the amount of the graft copolymer resin (B1) can be in a range from about any of the foregoing amounts to about any other of the foregoing amounts.

Further, in some embodiments, the rubber modified aromatic vinyl based copolymer resin (B) may not include the copolymer resin (B2) (i.e., the rubber modified aromatic vinyl based copolymer resin (B) may include 0% by weight of the copolymer resin (B2)). In some embodiments, the copolymer resin (B2) may be present in the rubber modified aromatic vinyl based copolymer resin (B), i.e., the rubber modified aromatic vinyl based copolymer resin (B) may include the copolymer resin (B2) in an amount of greater than and/or about 0, 1, 2, 3, 4, 5, 6, 7, 8, 9, 10, 11, 12, 13, 14, 15, 16, 17, 18, 29, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% by weight. Further, according to some embodiments of the present invention, the amount of the copolymer resin (B2) can be in a range from about any of the foregoing amounts to about any other of the foregoing amounts.

The flame retardant polycarbonate resin composition of the invention may include the rubber modified aromatic vinyl based copolymer resin (B) in an amount of about 0 to about 70% by weight, for example about 1 to about 50% by weight, and as another example about 5 to about 40% by weight, based on 100% by weight of the base resin (A+B). In some embodiments, flame retardant polycarbonate resin composition may not include the rubber modified aromatic vinyl based copolymer resin (B) (i.e., the flame retardant polycarbonate resin composition may include 0% by weight of the rubber modified aromatic vinyl based copolymer resin (B)). In some embodiments, the rubber modified aromatic vinyl based copolymer resin (B) may be present in the flame retardant polycarbonate resin composition, i.e., the flame retardant polycarbonate resin composition may include the rubber modified aromatic vinyl based copolymer resin (B) in an amount of greater than and/or about 0, 1, 2, 3, 4, 5, 6, 7, 8, 9, 10, 11, 12, 13, 14, 15, 16, 17, 18, 29, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70% by weight. Further, according to some embodiments of the present invention, the amount of the rubber modified aromatic vinyl based copolymer resin (B) can be in a range from about any of the foregoing amounts to about any other of the foregoing amounts.

(B1) Graft Copolymer Resin

The graft copolymer resin (B1) useful in the present invention may be prepared by adding an aromatic vinyl monomer, a monomer copolymerizable with the aromatic vinyl monomer to a rubbery polymer and polymerizing them together

Examples of the rubbery polymers may include without limitation diene-rubbers such as polybutadiene, poly(styrene-butadiene), poly(acrylonitrile-butadiene) and the like; saturated rubbers in which hydrogen is added to the diene-rubbers; isoprene rubbers, chloroprene rubbers; acrylic rubbers such as polybutyl acrylic acid; terpolymers of ethylene-propylene-diene (EPDM), and the like, and combinations thereof. The rubbers may be used alone or in combination with one another. In exemplary embodiments a diene rubber can be used, for example butadiene rubber can be used as a rubbery polymer.

The average size of the rubber particles can range from about 0.1 to about 4 μm taking into account the desired impact strength and appearance of the resin composition. In some embodiments, the average particle size of the rubber particles can range from about 0.1, 0.2, 0.3, 0.4, 0.5, 0.6, 0.7, 0.8, 0.9, 1, 2, 3, or 4 μm. Further, according to some embodiments of the present invention, the average particle size of the rubber particles can be in a range from about any of the foregoing sizes to about any other of the foregoing sizes.

Examples of the aromatic vinyl monomer that can be graft-copolymerized onto the rubber may include without limitation styrene, α-methylstyrene, β-methylstyrene, ρ-methylstyrene, and the like. These can be used singly or as a combination of at least two or more thereof.

The graft copolymer resin may include the aromatic vinyl monomer in an amount of about 34 to about 94% by weight. In some embodiments, the aromatic vinyl monomer may be used in an amount of about 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87 88, 89, 90, 91, 92, 93, or 94% by weight. Further, according to some embodiments of the present invention, the amount of the aromatic vinyl monomer can be in a range from about any of the foregoing amounts to about any other of the foregoing amounts.

One or more kind of monomers copolymerizable with the aromatic vinyl monomer may also be included. Examples of the monomer copolymerizable with the aromatic vinyl monomer may include without limitation vinyl cyanides such as acrylonitrile, unsaturated nitrile compounds such as methacrylonitrile, and the like. These can be used singly or as a combination of at least two or more thereof.

In exemplary embodiments, the graft copolymer resin may include the copolymerizable monomer in an amount of about 1 to about 30% by weight. In some embodiments, the monomer copolymerizable with the aromatic vinyl monomer may be used in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30% by weight. Further, according to some embodiments of the present invention, the amount of the monomer copolymerizable with the aromatic vinyl monomer can be in a range from about any of the foregoing amounts to about any other of the foregoing amounts.

The graft copolymer resin may also include one or more other monomers such as but not limited to acrylic acid, methacrylic acid, maleic acid anhydride, N-substituted maleimide, and the like, and combinations thereof, in order to impart good processability and heat resistance. The monomers can be used alone or in combination with one another.

These monomers may be used in an amount of about 0 to about 15% by weight, based on the total weight of the graft copolymer resin. In some embodiments, the graft copolymer resin may not include the monomer imparting processability and heat resistance (i.e., the graft copolymer resin may include 0% by weight of the monomer imparting processability and heat resistance). In some embodiments, the monomer imparting processability and heat resistance may be present in the graft copolymer resin, i.e., the graft copolymer resin may include the monomer imparting processability and heat resistance in an amount of greater than and/or about 0, 1, 2, 3, 4, 5, 6, 7, 8, 9, 10, 11, 12, 13, 14, or 15% by weight. Further, according to some embodiments of the present invention, the amount of the monomer imparting processability and heat resistance can be in a range from about any of the foregoing amounts to about any other of the foregoing amounts.

(B2) Copolymer Resin

The amount of the copolymer resin of the present invention is determined by the ratio of the monomers of the graft copolymer resin (B1) excluding rubber and compatibility. Therefore, the copolymer resin can be copolymerized using the equivalent amount of the monomers as the graft copolymer resin (B1) excluding rubber.

Examples of the aromatic vinyl monomer may include without limitation styrene, α-methyl styrene, β-methyl styrene, p-methyl styrene, p-t-butyl styrene, ethyl styrene, monochlorostyrene, dichlorostyrene, dibromostyrene, vinyl naphthalene, and the like, and combinations thereof. These aromatic vinyl monomers can be used alone or in combination with one another.

The copolymer resin may include the aromatic vinyl monomer in an amount of about 60 to about 90% by weight. In some embodiments, the aromatic vinyl monomer may be used in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% by weight. Further, according to some embodiments of the present invention, the amount of the aromatic vinyl monomer can be in a range from about any of the foregoing amounts to about any other of the foregoing amounts.

Examples of the monomer copolymerizable with the aromatic vinyl monomer may include without limitation, unsaturated nitrile compounds such as acrylonitrile and methacrylonitrile, and the like. These can be used singly or as a combination of at least two or more thereof.

The copolymer resin may include the copolymerizable monomer in an amount of about 10 to about 40% by weight. In some embodiments, the monomer copolymerizable with the aromatic vinyl monomer may be used in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40% by weight. Further, according to some embodiments of the present invention, the amount of the monomer copolymerizable with the aromatic vinyl monomer can be in a range from about any of the foregoing amounts to about any other of the foregoing amounts.

Examples of the monomer providing processability and heat resistance may include without limitation acrylic acid, methacrylic acid, maleic acid anhydride, N-substituted maleimide and the like, and combinations thereof. The graft copolymer resin may include the monomer providing processability and heat resistance in an amount of about 0 to about 30% by weight. In some embodiments, the copolymer resin (B2) may not include the monomer imparting processability and heat resistance (i.e., the copolymer resin may include 0% by weight of the monomer imparting processability and heat resistance). In some embodiments, the monomer imparting processability and heat resistance may be present in the copolymer resin (B2), i.e., the copolymer resin may include the monomer imparting processability and heat resistance in an amount of greater than and/or about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30% by weight. Further, according to some embodiments of the present invention, the amount of the monomer imparting processability and heat resistance can be in a range from about any of the foregoing amounts to about any other of the foregoing amounts.

(C) Phosphorous Compound

The phosphorous compound (C) of the present invention represented by the following Chemical Formula (I) can provide excellent flame retardant properties to the polycarbonate resin composition:

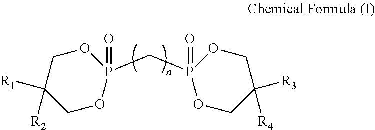

wherein:

R₁, R₂, R₃ and R₄ are each independently hydroxyl, phenol, phenyl, or C₁-C₄ alkyl; and

n is an integer of 1 to 10, for example n is 1 to 4.

Compounds represented by Chemical Formula (I) according to the present invention can be prepared by preparing an intermediate by reaction of an alkyldiol substituted with R₁, R₂, R₃ and/or R₄ and phosphorous trichloride, reacting the intermediate with triethylamine to dechlorinate the intermediate, and thereafter adding a 1,2-dibromoalkyl (wherein the alkyl is a C1 to C10 alkyl, such as 1,2-dibromoethane) in the presence of nitrogen at room temperature.

The fire retardant polycarbonate resin composition of the invention may include the phosphorous compound (C) in an amount of about 0.1 to about 40 parts by weight based on 100 parts by weight the base resin (A+B), for example about 1 to about 30 parts by weight, and as another example about 2 to about 20 parts by weight. In some embodiments, the polycarbonate resin composition can include the phosphorous compound (C) in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 parts by weight. Further, according to some embodiments of the present invention, the amount of the phosphorous compound (C) can be in a range from about any of the foregoing amounts to about any other of the foregoing amounts.

If an amount of the phosphorous compound (C) is less than about 0.1 parts by weight, it can be difficult to provide good flame retardancy. If the amount of the phosphorous compound (C) is more than about 40% by weight, however, it can be difficult to provide high mechanical strength.

In an exemplary embodiment of the present invention, the flame retardant polycarbonate composition may include the phosphorous compound (C) in an amount of about 1 to about 5 parts by weight, based on 100 parts by weight of the base resin, when the base resin comprises only polycarbonate.

In another exemplary embodiment of the present invention, the flame retardant polycarbonate composition may include the phosphorous compound (C) in an amount of about 10 to about 25 parts by weight, based on 100 parts by weight the base resin, when the base resin is a blend of the polycarbonate resin and the aromatic vinyl based copolymer resin.

The flame retardant polycarbonate resin composition according to the present invention may further include one or more additives. Exemplary additives include without limitation plasticizers, heat stabilizers, antioxidants, compatibilizers, light-stabilizers, inorganic additives, pigments, dyes and the like, and combinations thereof. Examples of the inorganic additives may include asbestos, glass fiber, talc, ceramic, sulfate and the like, and combinations thereof. The one or more additives may be used in an amount of less than about 30 parts by weight based on the total weight of the resin composition.

The flame retardant polycarbonate resin composition of the present invention can be prepared by known methods. For example, the components and optionally the additives can be mixed simultaneously, and the mixture can be extruded through an extruder to prepare pellets.

In another embodiment of the present invention, the present invention provides a molded article prepared from the flame retardant polycarbonate resin composition of the present invention. The molded article may have excellent flame retardancy and heat resistance. The molded article can be prepared using any suitable molding technique, such as but not limited to melt extrusion, injection molding, and the like. The skilled artisan will understand how to prepare a molded article using the flame retardant polycarbonate resin composition of the invention without undue experimentation.

The invention may be better understood by reference to the following examples which are intended for the purpose of illustration and are not to be construed as in any way limiting the scope of the present invention, which is defined in the claims appended hereto

### EXAMPLES AND COMPARATIVE EXAMPLES

Components used in the following examples and comparative examples are as follows.

(A) Polycarbonate Resin

Bisphenol-A based polycarbonate with a weight average molecular weight of 25,000 g/mol (Mw) made by Teijin Chemicals Ltd. of Japan (product name: Panlite L′1250 AP) is used.

(B) Rubber Modified Aromatic Vinyl Based Copolymer Resin

Rubber-reinforced styrene resin “CHT” produced by Cheil Industries, Inc. is used.

(C) The phosphorous compound

(C1) A phosphorous compound (C) of Chemical Formula (I) in which each R₁, R₂, R₃ and R₄ are a methyl group and n is 1 is used.

(C2) A phosphorous compound (C) of Chemical Formula (I) in which each R₁, R₂, R₃ and R₄ are a methyl group and n is 2 is used.

(D) Aromatic phosphoric ester compound

Aromatic phosphoric ester compound made by Daihachi Chemical Industry Company Ltd. of Japan (product name: CR-741S) is used

### Examples 1-8 and Comparative Examples 1-4

The components as shown in Table 1 are added to a conventional mixer, and the mixture is extruded through a conventional twin screw extruder at a temperature range of 200-280° C. to prepare a product in pellet form. The pellets are dried at 80° C. for 2 hours and then molded into test specimens for testing flame retardancy in an injection molding machine at 180-280° C. with a mold temperature of 40-80° C. Flame retardancy is determined by measuring the sum of 1st and 2nd combustion times for 5 specimens having a thickness of about ⅛″ in accordance with UL 94 VB. Heat deflection temperature is determined by measuring VST (Vicat Softening Temperature) at 5 kg in accordance with ISO R 306.

TABLE 1

| | | Examples | | | | | | | | Comparative Examples | | | |
|---|---|---|---|---|---|---|---|---|---|---|---|---|---|
| | | 1 | 2 | 3 | 4 | 5 | 6 | 7 | 8 | 1 | 2 | 3 | 4 |
| (A) carbonate resin | | 100 | 100 | 70 | 70 | 100 | 100 | 70 | 70 | 100 | 100 | 70 | 70 |
| (B) rubber modified aromatic | | — | — | 30 | 30 | — | — | 30 | 30 | — | — | 30 | 30 |
| vinyl based resin | | | | | | | | | | | | | |
| (C) phosphorous | (C1) | 2 | 3 | 18 | 21 | — | — | — | — | — | — | — | — |
| compound | (C2) | — | — | — | — | 2 | 3 | 18 | 21 | — | — | — | — |

| | | | | | | | | | | | | |
|---|---|---|---|---|---|---|---|---|---|---|---|---|
| (D) Aromatic phosphoric ester | — | — | — | — | — | — | — | — | 2 | 3 | 18 | 21 |
| compound | | | | | | | | | | | | |
| Flame retardancy (UL94, ⅛″) | V-0 | V-0 | V-1 | V-0 | V-0 | V-0 | V-1 | V-0 | V-1 | V-0 | V-1 | V-1 |
| Total combustion time | 34 | 21 | 69 | 24 | 49 | 32 | 84 | 32 | 74 | 41 | 109 | 81 |
| Heat deflection temperature (° C.) | 148 | 147 | 105 | 99 | 150 | 148 | 108 | 101 | 136 | 133 | 91 | 85 |

As represented in Table 1, Examples 1-8 which include the phosphorous compound of Chemical Formula (I) show significantly improved flame retardancy and heat deflection temperature and have short combustion times as compared with Comparative Examples 1-4 including only aromatic phosphoric ester compounds as a flame retardant.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A flame retardant polycarbonate resin composition comprising:
(A) about 30 to about 100% by weight of a polycarbonate resin;
(B) about 0 to about 70% by weight of a rubber modified aromatic vinyl based copolymer resin; and
(C) about 0.1 to about 40 parts by weight of a phosphorous compound or a combination of phosphorous compounds represented by the following Chemical Formula (I), per 100 parts by weight of a base resin comprising (A) and (B) 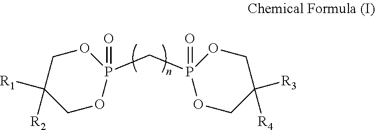
wherein R₁, R₂, R₃, and R₄ are each independently hydroxyl, phenol, phenyl, or C1-C4 alkyl; and
n is an integer of 1 to 10.

2. The flame retardant polycarbonate resin composition of claim 1, wherein the rubber modified aromatic vinyl based copolymer resin (B) is a polymer resin wherein a rubbery polymer is dispersed in the form of particles in a matrix of an aromatic vinyl polymer.

3. The flame retardant polycarbonate resin composition of claim 1, wherein the rubber modified aromatic vinyl based copolymer resin (B) comprises: about 10 to about 100% by weight of a graft copolymer resin (B1) comprising about 5 to about 65% by weight of a rubbery polymer, about 34 to about 94% by weight of an aromatic vinyl monomer, about 1 to about 30% by weight of a monomer copolymerizable with the aromatic vinyl monomer, and about 0 to about 15% by weight of one or more other monomers to impart good processability and heat resistance; and about 0 to about 90% by weight of copolymer resin (B2) comprising about 60 to about 90% by weight of an aromatic vinyl monomer, about 10 to about 40% by weight of a monomer copolymerizable with the aromatic vinyl monomer, and about 0 to about 30% by weight of one or more other monomers to impart good processability and heat resistance.

4. The flame retardant polycarbonate resin composition of claim 3, wherein aromatic vinyl monomer comprises styrene, α-methyl styrene, p-methyl styrene, or a combination thereof.

5. The flame retardant polycarbonate resin composition of claim 3, wherein the monomer copolymerizable with the aromatic vinyl monomer comprises an unsaturated nitrile compound.

6. The flame retardant polycarbonate resin composition of claim 3, wherein the one or more other monomers which impart good processability and heat resistance comprises acrylic acid, methacrylic acid, maleic acid anhydride, N-substituted maleimide, or a combination thereof.

7. The flame retardant polycarbonate resin composition of claim 1, comprising the polycarbonate resin (A) in an amount of about 40 to about 90% by weight.

8. The flame retardant polycarbonate resin composition of claim 7, comprising the polycarbonate resin (A) in an amount of about 50 to about 80% by weight.

9. The flame retardant polycarbonate resin composition of claim 8, comprising the polycarbonate resin (A) in an amount of about 60 to about 77% by weight.

10. The flame retardant polycarbonate resin composition of claim 1, comprising the rubber modified aromatic vinyl based copolymer resin (B) in an amount of about 1 to about 50% by weight.

11. The flame retardant polycarbonate resin composition of claim 10, comprising the rubber modified aromatic vinyl based copolymer resin (B) in an amount of about 5 to about 40% by weight.

12. The flame retardant polycarbonate resin composition of claim 3, wherein the rubber modified aromatic vinyl based copolymer resin (B) comprises about 55 to about 90% by weight of said graft copolymer resin (B1) and about 10 to about 45% by weight of said copolymer resin (B2).

13. The flame retardant polycarbonate resin composition of claim 3, wherein the rubber modified aromatic vinyl based copolymer resin (B) comprises about 15 to about 50% by weight of said graft copolymer resin (B1) and about 50 to about 85% by weight of said copolymer resin (B2).

14. The flame retardant polycarbonate resin composition of claim 1, comprising about 1 to about 30 parts by weight of said phosphorous compound (C).

15. The flame retardant polycarbonate resin composition of claim 14, comprising about 2 to about 20 parts by weight of said phosphorous compound (C).

16. The flame retardant polycarbonate resin composition of claim 14, comprising about 1 to about 5 parts by weight of said phosphorous compound (C).

17. The flame retardant polycarbonate resin composition of claim 14, comprising about 10 to about 25 parts by weight of said phosphorous compound (C).

18. The flame retardant polycarbonate resin composition of claim 1, wherein in Chemical Formula (I), each R₁, R₂, R₃, and R₄ is methyl and n is 1.

19. The flame retardant polycarbonate resin composition of claim 1, wherein in Chemical Formula (I), each R₁, R₂, R₃, and R₄ is methyl and n is 2.

20. The flame retardant polycarbonate resin composition of claim 1, further comprising about 0 to about 30 parts by weight of one or more additives selected from the group consisting of plasticizers, heat stabilizers, antioxidants, compatibilizers, light-stabilizers, inorganic additives, pigments, dyes, and combinations thereof.

21. A molded article prepared from the flame retardant polycarbonate resin composition of claim 1.
